(19) United States
(12) Patent Application Publication
(10) Pub. No.: US 2026/0289207 A1
(43) Pub. Date: Sep. 24, 2026

(54) PRINTING CONTROL APPARATUS, PRINTING CONTROL METHOD, AND NON-TRANSITORY COMPUTER-READABLE STORAGE MEDIUM STORING PRINTING CONTROL PROGRAM

(71) Applicant: SEIKO EPSON CORPORATION, TOKYO (JP)

(72) Inventor: Koki NOMURA, AZUMINO-SHI (JP)

(21) Appl. No.: 19/575,989

(22) Filed: Mar. 24, 2026

(30) Foreign Application Priority Data
Mar. 24, 2025 (JP) 2025-048115

(51) Int. Cl. G06K 15/12; G06F 3/12

(52) U.S. Cl. CPC G06K 15/129; G06F 3/1205; G06F 3/1253

(57) ABSTRACT

A printing control apparatus includes a reception unit, a generation unit that generates print data. When the reception unit receives image data including a first object to which a first spot color name is assigned, and a second object to which a second spot color name is assigned, the generation unit executes first print setting processing for the first object as setting processing indicating setting a printing color to a first color designated by the first object, and causing the printing apparatus to print the first color as the first object, executes second print setting processing for the second object as setting processing indicating setting printing colors to a second color designated by the second object and a third color not designated by the second object, and causing the printing apparatus to print the second color and the third color as the second object.

The present application is based on, and claims priority from JP Application Serial Number 2025-048115, filed March 24, 2025, the disclosure of which is hereby incorporated by reference herein in its entirety.

### BACKGROUND

### 1. Technical Field

The present disclosure relates to a printing control apparatus, a printing control method, and a non-transitory computer-readable storage medium storing a printing control program.

### 2. Related Art

In the related art, it is known to print a plurality of layers formed by various inks in an overlapping manner. For example, JP-A-2023-173407 discloses an example in which a color ink layer, a white ink layer, a color ink layer, and a varnish ink layer are laminated in order from the bottom.

JP-A-2023-173407 is an example of the related art.

However, when the multilayer printing as described above is performed, there is a problem that the setting work of the printing colors and the setting work of the printing layers are complicated.

### SUMMARY

A printing control apparatus according to an aspect of the present disclosure includes a reception unit that receives image data, a generation unit that generates print data based on the image data, and a control unit that controls a printing apparatus based on the print data, wherein, when the reception unit receives the image data including a first object to which a first spot color name is assigned as a spot color name, and a second object to which a second spot color name different from the first spot color name is assigned as a spot color name, the generation unit executes first print setting processing for the first object as setting processing indicating setting a printing color to a first color designated by the first object, and causing the printing apparatus to print a layer of the first color as the first object, executes second print setting processing for the second object as setting processing indicating setting printing colors to a second color designated by the second object and a third color not designated by the second object, and causing the printing apparatus to print a layer of the second color and a layer of the third color as the second object, and generates the print data reflecting the setting by the first print setting processing and the setting by the second print setting processing.

A printing control method according to an aspect of the present disclosure in a printing control apparatus having a reception unit that receives image data, a generation unit that generates print data based on the image data, and a control unit that controls a printing apparatus based on the print data, the method includes, when the reception unit receives the image data including a first object to which a first spot color name is assigned as a spot color name, and a second object to which a second spot color name different from the first spot color name is assigned as a spot color name, executing first print setting processing for the first object as setting processing indicating setting a printing color to a first color designated by the first object, and causing the printing apparatus to print a layer of the first color as the first object by the generation unit, executing second print setting processing for the second object as setting processing indicating setting printing colors to a second color designated by the second object and a third color not designated by the second object, and causing the printing apparatus to print a layer of the second color and a layer of the third color as the second object by the generation unit, and generating the print data reflecting the setting by the first print setting processing and the setting by the second print setting processing by the generation unit.

A non-transitory computer-readable storage medium storing a printing control program according to an aspect of the present disclosure causes a computer to function as a reception unit that receives image data, a generation unit that generates print data based on the image data, and a control unit that controls a printing apparatus based on the print data, wherein, when the reception unit receives the image data including a first object to which a first spot color name is assigned as a spot color name, and a second object to which a second spot color name different from the first spot color name is assigned as a spot color name, the generation unit executes first print setting processing for the first object as setting processing indicating setting a printing color to a first color designated by the first object, and causing the printing apparatus to print a layer of the first color as the first object, executes second print setting processing for the second object as setting processing indicating setting printing colors to a second color designated by the second object and a third color not designated by the second object, and causing the printing apparatus to print a layer of the second color and a layer of the third color as the second object, and generates the print data reflecting the setting by the first print setting processing and the setting by the second print setting processing.

A printing control apparatus according to an aspect of the present disclosure includes a reception unit that receives image data, a generation unit that generates print data based on the image data, and a control unit that controls a printing apparatus based on the print data, wherein, when the image data received by the reception unit contains an object to which a spot color name is assigned and which designates a specific color, the generation unit determines whether the spot color name assigned to the object contained in the image data includes a predetermined character string, and the generation unit executes setting processing for the object determined not to include the predetermined character string for setting a printing color to the specific color designated by the object, and causing the printing apparatus to print a layer of the specific color as the object, executes setting processing for the object determined to include the predetermined character string for setting printing colors to the specific color designated by the object and an additional color different from the specific color, and causing the printing apparatus to print a layer of the specific color and a layer of the additional color as the object, and generates the print data reflecting the setting by the setting processing for the object determined not to include the predetermined character string and the setting by the setting processing for the object determined to include the predetermined character string.

### BRIEF DESCRIPTION OF THE DRAWINGS

FIG. 1 is a block diagram showing configurations of a printing control apparatus and a printing apparatus.

FIG. 2 shows an example of a spot color list.

FIG. 3 shows an example of ink addition information.

FIG. 4 is a schematic diagram showing a plan view of an example of a printed material.

FIG. 5 is a schematic diagram showing a cross-sectional view of an example of the printed material.

FIG. 6 is a flowchart showing print data generation processing.

### DESCRIPTION OF EMBODIMENTS

Embodiments of the present disclosure will now be described in the following order.
(1) Overall Configuration
(1-1) Configuration of Printing Control Apparatus
(2) Print Data Generation Processing
(3) Other Embodiments

(1) Overall Configuration

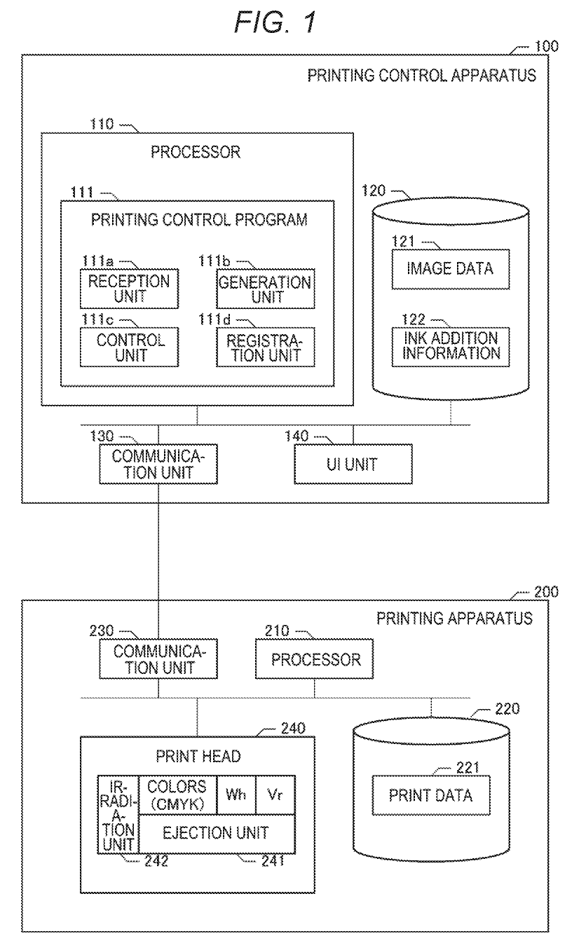

FIG. 1 is a block diagram illustrating a printing control apparatus 100 and a printing apparatus 200 according to the present embodiment. The printing control apparatus 100 of the present embodiment is an apparatus that generates print data 221 based on input image data 121 and causes the printing apparatus 200 to execute printing based on the print data 221, and is, for example, a personal computer, a tablet, or a smartphone. The printing apparatus 200 is an apparatus that prints an image on a print medium in response to an instruction from the printing control apparatus 100.

The printing apparatus 200 performs printing on a print medium using predetermined inks. In the present embodiment, the predetermined inks are color inks (inks of respective colors of cyan (C), magenta (M), yellow (Y), and black (K)) and spot color inks. The spot color ink is an ink used for representing a color that cannot be represented by the color inks, a base of a color ink layer, imparting gloss or a stereoscopic effect to a surface, and the like. The printing apparatus 200 of the present embodiment can use a white ink (Wh) and a varnish ink (Vr) as the spot color inks. The color inks and the spot color inks used by the printing apparatus 200 of the present embodiment are UV inks that are cured by irradiation of ultraviolet rays.

The printing apparatus 200 includes a processor 210, a storage medium 220, a communication unit 230, and a print head 240. The processor 210 includes a CPU, a RAM, and a ROM, and controls the printing apparatus 200 by executing a program stored in the ROM, the storage medium 220, or the like. The processor 210 may be implemented by a single chip, may be implemented by a plurality of chips, or may be implemented as an SoC with various function blocks that operate the printing apparatus 200. Alternatively, an ASIC may be employed instead of the CPU, or the CPU and the ASIC may cooperatively operate. When each apparatus in the present embodiment includes a processor, the processor can be implemented in various forms similar to the processor 210.

The communication unit 230 includes a circuit used for communication with an external apparatus such as the printing control apparatus 100 according to various wired or wireless communication protocols. The storage medium 220 stores various programs including a print execution program for controlling execution of printing and various kinds of information. When the print data 221 is received from the printing control apparatus 100, the print data 221 is stored in the storage medium 220 at least until the printing indicated by the print data 221 is completed.

The print head 240 ejects the UV inks to the print medium and irradiates the print medium with ultraviolet rays. The processor 210 performs ejection of the inks and irradiation with ultraviolet rays on the print medium while moving the print head 240 via the drive mechanism of the print head 240. The print head 240 includes an ejection unit 241 used to eject various inks and an irradiation unit 242 that irradiates the inks ejected by the ejection unit 241 with ultraviolet rays. The ejection unit 241 is a nozzle used for ejecting each ink of the color ink (CMYK), the white ink, and the varnish ink, and applies each ink to the print medium by ejecting each ink to the print medium. The irradiation unit 242 is a lamp that is disposed in the ejection unit 241 for irradiation of ultraviolet rays.

When the communication unit 230 receives the print data 221, the processor 210 controls the print head 240 according to the print data of each layer contained in the print data 221 to execute printing. The processor 210 produces a printed material in which a plurality of layers are laminated by performing printing based on the print data of all the layers contained in the print data 221.

### 1-1. Configuration of Printing Control Apparatus

The printing control apparatus 100 transmits the print data 221 to the above-described printing apparatus 200 and causes the printing apparatus 200 to execute printing based on the print data 221. The printing control apparatus 100 includes a processor 110, a storage medium 120, a communication unit 130, and a UI unit 140. The processor 110 includes a RAM, a ROM, a CPU, and the like, and controls the printing control apparatus 100 by executing various programs stored in the ROM, the storage medium 120, and the like.

The communication unit 130 includes a circuit used for communication with an external apparatus such as the printing apparatus 200 according to various wired or wireless communication protocols. The UI unit 140 includes an input unit that receives a user operation on a mouse, a keyboard, a touch pad, a touch panel, or the like, and an output unit used to present information to the user, such as a display (display unit) and a speaker.

The storage medium 120 stores various programs including a printing control program 111 for causing the printing apparatus 200 to execute printing, and various kinds of information such as the image data 121 and ink addition information 122.

The image data 121 is a file of an image to be printed, for example, a PDF file. In the present embodiment, the image data 121 includes an object expressed in a vector format. In the image data 121, a color, a position in an image, a size, and the like are designated for each object. As the color of the object, a spot color name may be assigned.

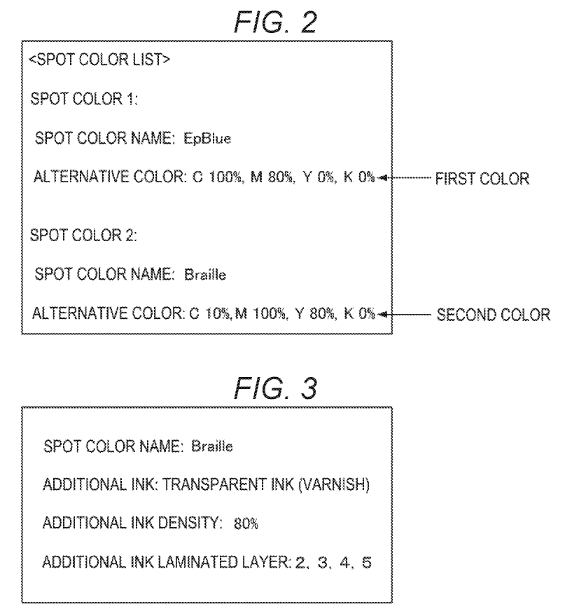

When the image data 121 includes an object (spot color object) to which a spot color name is assigned, for example, a file header of the image data 121 includes a spot color list in which information on the spot color name used for the spot color object contained in the image data 121 is listed. In the spot color list, as shown in FIG. 2, spot color names and information of alternative colors for objects to which spot color names are assigned are shown in association with each other. That is, in the image data 121, an alternative color is designated for an object to which a spot color name is assigned. The alternative color is information indicating a color represented when an object to which a spot color name is assigned is displayed on the display unit or a color represented when printing is performed without using the spot color ink indicated by the spot color name. In the present embodiment, the alternative color is indicated by a value indicating the density of each color ink color of CMYK. The spot color list may include at least one specific spot color name described later. In the spot color list illustrated in FIG. 2, two spot colors of SPOT COLOR 1 and SPOT COLOR 2 are listed, but the number thereof is not particularly limited as long as the number is at least one.

The ink addition information 122 is information related to a layer automatically added to be laminated on an object when the object to which a specific spot color name is assigned is printed. The ink addition information 122 is referred to when the processor 110 generates the print data 221 from the image data 121 by the printing control program 111. Here, the specific spot color name is a spot color name including a predetermined character string.

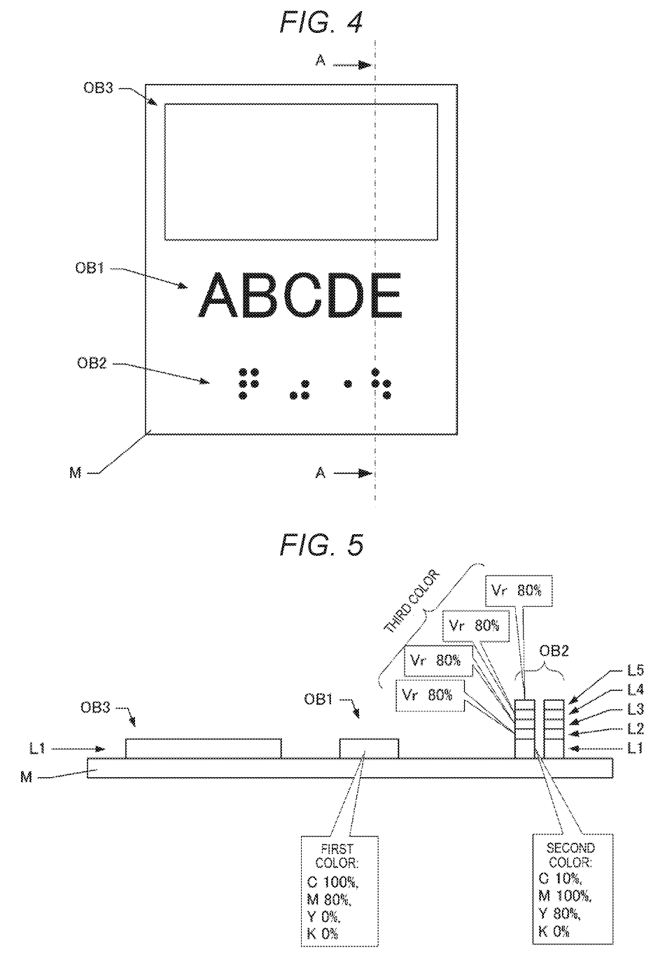

As illustrated in FIG. 3, the ink addition information 122 stores, for a specific spot color name, the type of the additional ink to be added for printing an object to which the spot color name is assigned, the density of the additional ink, and the laminated layer of the additional ink. The example in FIG. 3 shows that, for an object to which a spot color name "Braille" is assigned, the varnish, which is a transparent ink, is printed at density of 80% in each of the second, third, fourth, and fifth layers. The number shown as a laminated layer indicates the lamination order (printing order) counted from the print medium (base material). The details will be described later with reference to FIG. 4.

The processor 110 can execute the printing control program 111 having a function of generating the print data 221 based on the image data 121 to be printed and causing the printing apparatus 200 to execute printing based on the print data 221. By executing the printing control program 111, the processor 110 functions as a reception unit 111a, a generation unit 111b, a control unit 111c, and a registration unit 111d. The processor 110 receives the image data 121 to be printed by the function of the reception unit 111a. As described above, the image data 121 includes information such as the position, size, and color of the object. When the image data 121 includes an object to which a spot color name is assigned, the image data 121 includes a spot color list as illustrated in FIG. 2.

With the function of the generation unit 111b, the processor 110 generates the print data 221 for causing the printing apparatus 200 to execute printing based on the image data 121. Furthermore, with the function of the control unit 111c, the processor 110 controls the printing apparatus 200 based on the print data 221. That is, the processor 110 transmits the print data 221 to the printing apparatus 200 and causes the printing apparatus 200 to execute printing indicated by the print data 221. In the present embodiment, the print data 221 is halftone data generated for each of a plurality of layers. The halftone data is data that defines the presence or absence of ejection of the ink of each ink color of the printing apparatus 200 and the size of ink droplets for each pixel.

When the received image data 121 includes an object to which a spot color name is assigned and which designates a specific color, the processor 110 determines whether the spot color name assigned to the object contained in the image data 121 includes a predetermined character string by the generation unit 111b. Specifically, the processor 110 analyzes the spot color list contained in the image data 121 and determines whether a predetermined character string indicating the spot color name contained in the ink addition information 122 is set as the spot color name of each object.

The processor 110 sets the printing color of the object determined not to include the predetermined character string in the spot color name among the objects to which the spot color names are assigned to the specific color designated by the object, and executes setting processing for causing the printing apparatus 200 to print the layer of the above-described specific color as the object. The processor 110 sets the printing colors of the object determined to include the predetermined character string in the spot color name to a specific color designated by the object and an additional color different from the specific color, and executes setting processing for causing the printing apparatus 200 to print a layer of the specific color and a layer of the additional color as the object.

The processor 110 generates the print data 221 reflecting the setting by the setting processing for the object determined not to include the predetermined character string and the setting by the setting processing for the object determined to include the predetermined character string. That is, the processor 110 generates the print data 221 indicating that the layer of the specific color designated by the object is printed for the object not including the predetermined character string, and the layer of the specific color designated by the object and the layer of the additional color different from the specific color are printed for the object including the predetermined character string. According to the configuration, when the spot color name assigned to the object includes the predetermined character string, it is possible to automatically generate the print data for printing the layer of the additional color in addition to the layer of the specific color designated by the object for the object.

For example, a case where image data 121 including a first object OB1 to which a first spot color name ("EpBlue" in the present embodiment) is assigned as a spot color name and a second object OB2 to which a second spot color name ("Braille" in the present embodiment) different from the first spot color name is assigned as a spot color name is received will be described. In this case, the image data 121 includes a spot color list as illustrated in FIG. 2. In the present embodiment, the predetermined character string defined in the ink addition information 122 is "Braille" as the second spot color name. The processor 110 analyzes the spot color list of the image data 121 and determines that the second object OB2 is an object to which the predetermined character string "Braille" is assigned and the first object OB1 is not an object to which the predetermined character string is assigned.

The processor 110 sets the printing color of the first object OB1 to a first color designated by the first object OB1. In the present embodiment, as illustrated in FIG. 2, the first color is a color in which the density of cyan is 100%, the density of magenta is 80%, the density of yellow is 0%, and the density of black is 0%. The processor 110 executes first print setting processing that is setting processing for causing the printing apparatus 200 to print the layer of the first color as the first object OB1. In the present embodiment, the first print setting processing includes a setting indicating that the first object OB1 is printed in the first color in the first layer counted from the print medium, that is, in the first layer in the printing order.

For the second object OB2, the processor 110 sets the printing color to a second color designated by the second object OB2 and a third color not designated by the second object OB2. In the present embodiment, as illustrated in FIG. 2, the second color is a color in which the density of cyan is 10%, the density of magenta is 100%, the density of yellow is 80%, and the density of black is 0%. The third color not designated by the second object OB2 is determined by the ink addition information 122. In the ink addition information 122 of the present embodiment, the third color is a color in which the density of the varnish as the transparent ink is 80% as shown in FIG. 3. Since the varnish is a transparent ink, the color in which the density of the varnish is 80% is also transparent. Therefore, according to the present embodiment, it is possible to print a transparent layer of the transparent ink for the second object OB2.

The processor 110 executes second print setting processing that is setting processing for causing the printing apparatus 200 to print the layer of the second color and the layer of the third color as the second object OB2. In the present embodiment, the second print setting processing includes a setting indicating that the second object OB2 is printed as the second color layer in the first layer in the printing order, and a setting indicating that the second object OB2 is printed as the third color layer in the second, third, fourth, and fifth layers in the printing order (see FIG. 3). Here, when the spot color list is different from that in FIG. 2 and there is no spot color name not including the predetermined character string, the first print setting processing is not executed. Similarly, when there is no spot color name including the predetermined character string in the spot color list, the second print setting processing is not executed.

The processor 110 generates the print data 221 reflecting the setting by the first print setting processing and the setting by the second print setting processing. That is, for each layer of the image data 121, the processor 110 arranges and renders the object contained in the layer in the color determined as described above at the position of the object predetermined in the image data 121 in the size of the object predetermined in the image data 121, performs halftone processing, thereby generating the print data 221 including the print data for each layer. The print data 221 may be data rearranged according to a pass at the time of execution of printing in the printing apparatus 200.

The processor 110 sets a color predetermined in the image data 121 as the color of the third object OB3 as the printing color for the third object OB3 to which the spot color name is not assigned. Specifically, for the third object OB3, which is a non-spot color object, the processor 110 arranges the third object OB3 in the color, the position, and the size predetermined in the image data 121 as the color of the third object OB3 when generating the print data of the first layer in the printing order. The processor 110 generates print data of the first layer in the printing order by rendering the third object OB3 arranged in this manner and the first object OB1 and the second object OB2 arranged in the above-described manner and performing halftone processing.

When the generation of the print data 221 is completed, the processor 110 transmits the print data 221 to the printing apparatus 200. When receiving the print data 221, the processor 210 of the printing apparatus 200 executes printing based on the print data of each layer according to the printing order indicated by the print data 221.

FIG. 4 is a schematic diagram showing a plan view of a print medium M on which printing is sequentially performed based on the print data of each layer generated in the above-described manner. FIG. 5 is a schematic diagram showing a cross-sectional view taken along line A-A shown in FIG. 4.

In the example illustrated in FIGS. 4 and 5, the third object OB3 is an object to which no spot color name is assigned. As illustrated in FIG. 2, the first object OB1 is an object to which "EpBlue" is assigned as a spot color name. The second object OB2 is an object to which "Braille" is assigned as a spot color name.

As illustrated in FIG. 5, the third object OB3, the first object OB1, and the second object OB2 are printed based on the print data of a first layer L1 in the printing order by the printing apparatus 200. The color of the first object OB1 is the first color, and the color of the second object OB2 is the second color. That is, the first-color layer in the first object OB1 and the second-color layer in the second object OB2 are layers contained in the first layer L1, which is the same color layer. Therefore, according to the present embodiment, it is possible to print the layer of the first color as the first object OB1 and the layer of the second color as the second object OB2 in the first layer L1 as the same color layer.

Furthermore, the second object OB2 is printed as a layer of the third color (varnish 80%) based on the print data of a second layer L2 in the printing order by the printing apparatus 200. Similarly, the second object OB2 is printed in the third color based on the print data of a third layer L3 in the printing order. The second object OB2 is printed in the third color based on the print data of a fourth layer L4 in the printing order. The second object OB2 is printed in the third color based on the print data of a fifth layer L5 in the printing order. That is, according to the present embodiment, with respect to the second object OB2, four transparent ink layers can be printed so as to overlap the layer of the second color, which is the alternative color designated by the second object OB2. As a result, the second object OB2 can be printed to be raised, and the second object OB2 can be provided with a stereoscopic effect. As shown in FIG. 4, it may be assumed that the second object OB2 is, for example, an object indicating Braille.

The first print setting processing does not include setting processing of setting the printing color of the first object OB1 to the third color not designated by the first object OB1 for causing the printing apparatus 200 to print a layer of the third color as the first object OB1. That is, since the spot color name assigned to the first object OB1 does not include the predetermined character string "Braille" defined in the ink addition information 122, the processor 110 does not perform the setting for printing the third color, that is, the transparent layer by the varnish ink for the first object OB1. Therefore, the print data of the second layer L2 to the fifth layer L5 does not contain data for forming the first object OB1. According to the configuration, it is possible to prevent the layer of the third color (the transparent layer by the varnish ink) from being printed for the first object OB1.

As described above, according to the present embodiment, it is possible to automatically generate the print data for printing the layer of the third color not designated by the second object OB2. In the related art, when producing a printed material in which a color layer printed with color inks of C, M, Y, and K and a transparent layer printed with a transparent ink are laminated, a user needs to prepare, for example, two types of image data to be printed with the color inks and image data to be printed with the transparent ink. However, it is difficult to create such image data, and it takes time to create the image data. In addition, a loss due to time or waste paper is likely to occur due to a setting error of image data or the like. According to the present embodiment, the user does not need to prepare a plurality of pieces of image data when producing one type of printed material realized by multilayer printing. The user may assign the spot color name of the predetermined character string to the second object OB2 for which the user wishes to print the layer of the third color (transparent ink) in one piece of image data 121. The printing control apparatus 100 automatically generates print data for printing the layer of the third color (transparent ink) for the second object OB2 to which the spot color name of the predetermined character string is assigned based on the ink addition information 122 stored in advance. Therefore, according to the present embodiment, the burden on the user who creates the image data can be reduced, and the efficiency of the workflow in the multilayer printing can be improved.

By the registration unit 111d, the processor 110 receives registration of the above-described predetermined character string from the user. The processor 110 receives, from the user, information indicating the additional ink, the additional ink density, and the additional ink laminated layer for the spot color name indicated by the predetermined character string. The processor 110 stores the received predetermined character string as the ink addition information 122. With the function of the registration unit 111d, the processor 110 can automatically generate print data for printing a layer of an additional color different from the specific color designated by the object for the object including the predetermined character string registered by the user in the spot color name. Furthermore, with the registration unit 111d, the processor 110 may be configured to edit the predetermined character string, the additional ink, the additional ink density, and the laminated layer of the additional ink that have been already registered in addition to the new registration of the predetermined character string, the additional ink, the additional ink density, and the laminated layer of the additional ink.

### 2. Print Data Generation Processing

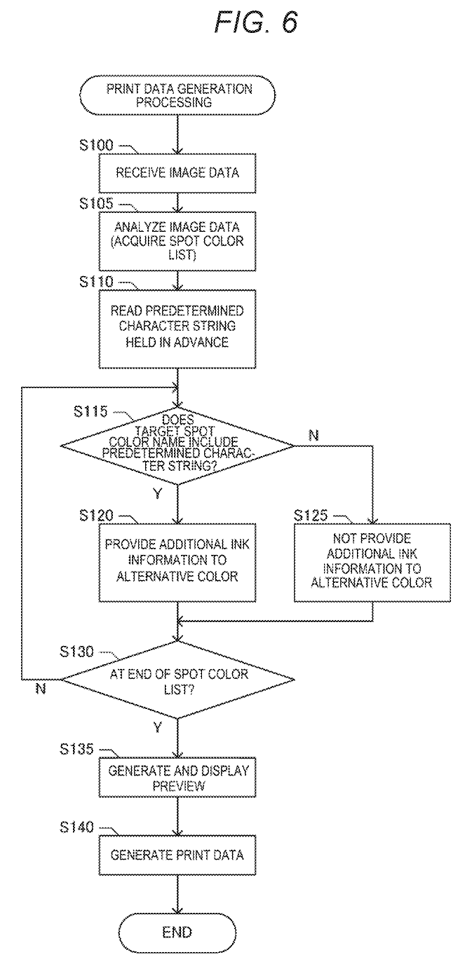

FIG. 6 is a flowchart showing print data generation processing. The print data generation processing is started when the user activates the printing control program 111 in the printing control apparatus 100 and inputs the image data 121 to be printed to the printing control program 111. When the print data generation processing is started, the processor 110 receives the input image data 121 by the processing of the reception unit 111a (step S100).

Subsequently, the processor 110 analyzes the image data 121 by the processing of the generation unit 111b (step S105). That is, the processor 110 acquires information indicating the position, the size, the color, and the like of each object contained in the image data 121 and the content of the spot color list (for example, see FIG. 2).

Subsequently, the processor 110 reads a predetermined character string held in advance by the printing control apparatus 100 by the processing of the generation unit 111b (step S110). That is, the processor 110 acquires a predetermined character string indicating a spot color name defined in the ink addition information 122 (for example, see FIG. 3).

Subsequently, the processor 110 repeats the processing from step S115 to step S130 one by one for the spot color names contained in the spot color list by the processing of the generation unit 111b. In step S115, the processor 110 determines whether the spot color name to be processed includes a predetermined character string.

When it is determined in step S115 that the spot color name to be processed includes the predetermined character string, the processor 110 provides additional ink information to the alternative color by the processing of the generation unit 111b (step S120). That is, for an object to which the spot color name including the predetermined character string is assigned, the processor 110 sets the printing color to a specific color designated by the object and an additional color different from the specific color, and executes setting processing for causing the printing apparatus 200 to print a layer of the specific color and a layer of the additional color as the object. When the predetermined character string is a character string (Braille) indicating the second color and the spot color name to be processed is the second color (Braille), the processing of step S120 corresponds to the second print setting processing described above.

When it is not determined in step S115 that the spot color name to be processed includes the predetermined character string, the processor 110 does not provide the additional ink information to the alternative color by the processing of the generation unit 111b (step S125). That is, the processor 110 sets the printing color of the object to which the spot color name not including the predetermined character string is assigned to the specific color designated by the object, and executes setting processing for causing the printing apparatus 200 to print the layer of the above-described specific color as the object. When the predetermined character string is a character string (Braille) indicating the second color and the spot color name to be processed is the first color (EpBlue), the processing of step S125 corresponds to the first print setting processing described above.

After executing step S120 or step S125, the processor 110 determines whether the spot color name is at the end of the spot color list (the processing has been completed for all the spot color names contained in the spot color list) by the processing of the generation unit 111b, and returns to step S115 when determining that the spot color name is not at the end.

When determining that the spot color name is at the end in step S130, the processor 110 generates and displays a preview by the processing of the generation unit 111b (step S135). In the preview image, the object to which the spot color name of the predetermined character string is assigned is represented in a mode indicating that the object is to be printed in a laminated manner. For example, the object to which the spot color name of the predetermined character string is assigned is displayed such that an object having the same shape as that of the object and having a color imitating an ink color to be laminated partially overlaps (partially overlaps by shifting the position) an object having a color indicated by the alternative color designated by the object. The object to which the spot color name not including the predetermined character string is assigned is displayed in the color indicated by the alternative color designated by the object. The object to which the spot color name not including the predetermined character string is assigned is not displayed by partially overlapping an object having a color imitating an ink color to be laminated, and thus is represented in a mode indicating that the object is not printed in the laminated manner. For the object to which no spot color name is assigned, the object is displayed in the color of the object.

After step S135, the user can also edit the image data 121. For example, the user may change the size or position of the object. When the user edits the image data, a preview showing the image data reflecting the edited content is generated and displayed. When the user checks the preview image displayed on the display unit of the UI unit 140 and instructs the generation of the print data, the processor 110 generates the print data 221 based on the image data 121 by the processing of the generation unit 111b (step S140). When the image data 121 received in step S100 is edited, the processor 110 generates the print data 221 based on the image data 121 reflecting the edited content. The processor 110 generates the print data reflecting the setting by the setting processing in step S120 or S125 for the object to which the spot color name is assigned. That is, the processor 110 generates the print data 221 indicating that the layer of the specific color designated by the object is printed for the object not including the predetermined character string in the spot color name among the objects to which the spot color names are assigned, and the layer of the specific color designated by the object and the layer of the additional color different from the specific color are printed for the object including the predetermined character string in the spot color name. Specifically, for example, as shown in FIG. 5, the processor 110 generates the print data for each layer in order from the first layer L1 in the printing order.

When the user instructs execution of printing, the processor 110 transmits the generated print data 221 to the printing apparatus 200 to execute printing based on the print data 221 by the processing of the control unit 111c. When the user instructs to suspend execution of printing and store the print data 221, the processor 110 stores the generated print data 221 in the storage medium 120.

### 3. Other Embodiments

The above-described embodiment is an example for implementing the present disclosure, and various other embodiments can be adopted. For example, the printing control apparatus 100 and the printing apparatus 200 may be integrated hardware, and the above-described processing may be performed by the printing control apparatus provided in the printing apparatus 200.

The additional ink may be printed as any layer. In the above embodiment, the second-color layer is a lower layer than the third-color layer, but the second-color layer may be an upper layer than the third-color layer. For example, the layer of the transparent ink may be a lower layer than the color layer of the color ink.

A configuration in which the third color is a printing color by a white ink may be adopted. According to the configuration, it is possible to automatically add and print a layer of the white ink for the second object. When the third color is a printing color by a white ink, for example, the layer of the third color may be configured as a base of the color layer in which printing by the color ink is performed.

The generation unit may be configured to, when receiving a color replacement instruction for replacing the second color with a fourth color for the second object from the user, set the printing color for the second object to the fourth color and the third color, execute color replacement processing that is setting processing for causing the printing apparatus to print a layer of the fourth color and a layer of the third color as the second object, and generate the print data reflecting the setting by the color replacement processing. According to the configuration, when the user instructs to replace the second color with the fourth color, the layer of the second color can be replaced with the layer of the fourth color without changing the setting for the layer of the third color.

For example, in the case of the example illustrated in FIG. 5, when the user gives an instruction to replace the color of the first layer L1 from the second color to the fourth color for the second object OB2, the generation unit generates the print data of the first layer L1 based on the image in which the second object OB2 of the fourth color is arranged in the first layer L1, and generates the print data of each layer based on the image in which the second object OB2 of the third color is arranged for the second layer L2 to the fifth layer L5. Therefore, the user does not need to give an instruction for the layer of the third color, and the time and effort of the user can be reduced.

The generation unit may be configured to, when the color designated by the second object is the second color, generate the print data for printing the second object using the fifth color finely adjusted based on the second color. For example, as illustrated in FIG. 5, when the second object OB2 of the second color is printed in the first layer L1 and the second object OB2 of the third color is printed in the second layer L2 to the fifth layer L5, the colorimetric value of the second object OB2 may be different from the second color depending on the type of the third color. Therefore, for example, the printing operator specifies the fifth color for bringing the colorimetric value of the second object OB2 close to the second color when the four layers of the third color are printed on the lowermost layer, and registers the fifth color in the printing control apparatus 100. When the color designated by the second object OB2 in the image data 121 is the second color, the generation unit may automatically replace the second color with the fifth color. The generation unit generates the print data of the first layer L1 based on the image in which the second object OB2 of the fifth color is arranged in the first layer L1, and generates the print data of each layer based on the image in which the second object OB2 of the third color is arranged for the second layer L2 to the fifth layer L5. According to the configuration, when the color designated by the second object OB2 is the second color, the colorimetric value of the second object OB2 formed by printing all the layers including the layer of the third color not designated by the second object OB2 can be a color close to the second color.

In the above-described embodiment, the alternative color of the object to which the spot color name is assigned in the image data is designated in the image data, but the printing control apparatus 100 may be configured to hold a value indicating the alternative color in advance for each spot color name. In this case, a configuration may be adopted in which the generation unit determines the printing color of the object to which the spot color name is assigned with reference to the information of the alternative color held in the printing control apparatus 100.

"Braille" is an example of the spot color name to be assigned to an object to be subjected to raised printing, and the predetermined character string is not limited to "Braille" and various character strings may be adopted.

Furthermore, the present disclosure is also applicable as a non-transitory computer-readable storage medium storing a printing control program executed by a computer and a printing control method. The system, the program, and the method described above are implemented in some cases as a single apparatus, or are implemented in other cases by using components provided in multiple apparatuses, and include various aspects. Also, suitable changes can be made, such as a part being software and a part being hardware. The disclosure is further implemented as a recording medium for a program for controlling the system. Obviously, the recording medium for the program may be a magnetic recording medium or a semiconductor memory, and any recording medium to be developed in the future can be considered in exactly the same way.

What is claimed is:

1. A printing control apparatus comprising:
a reception unit that receives image data;
a generation unit that generates print data based on the image data; and
a control unit that controls a printing apparatus based on the print data, wherein
when the reception unit receives the image data including a first object to which a first spot color name is assigned as a spot color name, and a second object to which a second spot color name different from the first spot color name is assigned as a spot color name,
the generation unit executes first print setting processing for the first object as setting processing indicating setting a printing color to a first color designated by the first object, and causing the printing apparatus to print a layer of the first color as the first object, executes second print setting processing for the second object as setting processing indicating setting printing colors to a second color designated by the second object and a third color not designated by the second object, and causing the printing apparatus to print a layer of the second color and a layer of the third color as the second object, and generates the print data reflecting the setting by the first print setting processing and the setting by the second print setting processing.

2. The printing control apparatus according to claim 1, wherein
the first print setting processing does not include setting processing for the first object for setting a printing color to the third color not designated by the first object and causing the printing apparatus to print a layer of the third color as the first object.

3. The printing control apparatus according to claim 1, wherein
the layer of the first color and the layer of the second color are layers contained in a same color layer.

4. The printing control apparatus according to claim 1, wherein
the third color is a printing color by at least one of a transparent ink and a white ink.

5. The printing control apparatus according to claim 1, wherein
when receiving a color replacement instruction to replace the second color with a fourth color for the second object from a user, the generation unit executes color replacement processing that is setting processing for setting printing colors to the fourth color and the third color for the second object, and causing the printing apparatus to print a layer of the fourth color and a layer of the third color as the second object, and generates the print data reflecting the setting by the color replacement processing.

6. A printing control method in a printing control apparatus having a reception unit that receives image data, a generation unit that generates print data based on the image data, and a control unit that controls a printing apparatus based on the print data, the method comprising:
when the reception unit receives the image data including a first object to which a first spot color name is assigned as a spot color name, and a second object to which a second spot color name different from the first spot color name is assigned as a spot color name,
executing first print setting processing for the first object as setting processing indicating setting a printing color to a first color designated by the first object, and causing the printing apparatus to print a layer of the first color as the first object by the generation unit;
executing second print setting processing for the second object as setting processing indicating setting printing colors to a second color designated by the second object and a third color not designated by the second object, and causing the printing apparatus to print a layer of the second color and a layer of the third color as the second object by the generation unit; and
generating the print data reflecting the setting by the first print setting processing and the setting by the second print setting processing by the generation unit.

7. A printing control apparatus comprising:
a reception unit that receives image data;
a generation unit that generates print data based on the image data; and
a control unit that controls a printing apparatus based on the print data, wherein
when the image data received by the reception unit contains an object to which a spot color name is assigned and which designates a specific color, the generation unit determines whether the spot color name assigned to the object contained in the image data includes a predetermined character string, and
the generation unit executes setting processing for the object determined not to include the predetermined character string for setting a printing color to the specific color designated by the object, and causing the printing apparatus to print a layer of the specific color as the object, executes setting processing for the object determined to include the predetermined character string for setting printing colors to the specific color designated by the object and an additional color different from the specific color, and causing the printing apparatus to print a layer of the specific color and a layer of the additional color as the object, and generates the print data reflecting the setting by the setting processing for the object determined not to include the predetermined character string and the setting by the setting processing for the object determined to include the predetermined character string.

8. The printing control apparatus according to claim 7, further comprising a registration unit that receives registration of the predetermined character string from a user.
